(19) United States
(12) Patent Application Publication
(10) Pub. No.: US 2022/0033660 A1
(43) Pub. Date: Feb. 3, 2022

(54) PUMPABLE, THERMALLY EXPANDABLE PREPARATION

(71) Applicant: Henkel AG & Co. KGaA, Duesseldorf (DE)

(72) Inventors: Ralf Sauer, St. Leon-Rot (DE); Michael Klotz, Edingen-Neckarhausen (DE); Takehito Yamada, Heidelberg (DE)

(21) Appl. No.: 17/450,861

(22) Filed: Oct. 14, 2021

Related U.S. Application Data
(63) Continuation of application No. PCT/EP2020/057027, filed on Mar. 16, 2020.

(30) Foreign Application Priority Data
Apr. 16, 2019 (EP) 19169378.7

(51) Int. Cl. C09D 5/02; C09D 5/34; C09D 157/00

(52) U.S. Cl. CPC C09D 5/021; C09D 157/00; C09D 5/34; C09D 5/024

(57) ABSTRACT

The present application relates to a preparation that is pumpable, thermally curable and expandable at application temperatures, typically in the range of 30 to 120° C., and contains at least one solid rubber, at least one liquid rubber, at least one thermally activatable blowing agent and a curing agent system containing at least one peroxide and at least one quinone, quinone dioxime or dinitrosobenzene, to a method for stiffening structural components having thin-walled structures using such preparations or for sealing cavities in structural components using such preparations, and to the use of these preparations for stiffening such structures or for sealing cavities in structural components.

The present application relates to a preparation that is pumpable, thermally curable and expandable at application temperatures, typically in the range of 30 to 120° C., and contains the constituents disclosed herein, to a method for stiffening structural components having thin-walled structures using such preparations or for sealing cavities in structural components using such preparations, and to the use of these preparations for stiffening such structures or for sealing cavities in structural components.

Modern vehicles and vehicle parts have a large number of cavities which have to be sealed to prevent the entry of moisture and dirt, since this can lead to corrosion of the corresponding body parts from the inside out. This applies in particular to modern self-supporting body structures in which a heavy frame construction is replaced by lightweight, structurally stable frameworks made of prefabricated cavity profiles. As a result of this system, structures of this kind have a series of cavities that have to be sealed against the ingress of moisture and dirt. Seals of this kind are also used for the purpose of preventing the transmission of airborne sound in cavities of this kind, and thus to reduce unpleasant vehicle running noises and wind noises and thus to increase the driving comfort in the vehicle.

Frame and body parts containing such cavities can, for example, be prefabricated from half-shell structural components which are joined to form the closed hollow profile at a later point in time by welding and/or gluing. With such a construction, the cavity is therefore easily accessible in the early construction stage of a vehicle body, so that sealing and acoustically damping baffle parts can be fixed in this phase of the body assembly by mechanical hanging, by insertion into corresponding holding devices, or bores, or by welding. Furthermore, such hollow profiles can be produced from steel, aluminum or plastics materials in the extrusion process, by hydroforming, by die casting or by drawing processes. The resulting cavities are only accessible through the cross-sectional openings at the end of these profiles.

Baffle parts that cause a sealing and/or acoustic effect in cavities of this kind are often referred to as “pillar fillers,” “baffles” or “acoustic baffles.” They usually consist either completely of thermally expandable molded bodies or of molded bodies containing a carrier and expandable polymeric preparations in the peripheral region thereof. These baffle parts are fastened to the open structures by means of hanging, clipping, screwing or welding during body assembly. After closing the structures during body assembly and further pretreating the body, the process heat of the furnaces for curing the cathodic dip paint is then used to trigger the expansion of the expandable part of the baffle part in order to thus seal the cross section of the cavity.

Moreover, for many fields of application, there is need for lightweight structural components that are intended for dimensionally consistent batch production and have high rigidity and structural strength. In vehicle construction in particular, given the desire to reduce weight, there is great need for lightweight structural components consisting of thin-walled structures which nevertheless have adequate rigidity and structural strength. One way to achieve high rigidity and structural strength while keeping the weight of the structural component as low as possible is to use hollow parts made from relatively thin sheet metal or plastics sheets. However, thin-walled sheet metal tends to deform easily. Therefore, in the case of hollow body structures, it has been known for some time to fill the cavity with a structural foam, completely or only partially, for example in portions subject to particularly high levels of mechanical stress. This can result in deformations or distortions being minimized, or even completely prevented, and in the strength and rigidity of the hollow body structures being increased.

Such foamed reinforcing and stiffening agents are usually either metal foams or are made from thermally curable and expandable preparations, for example based on epoxy resins. In the latter case, the preparations are usually provided in the form of thermally curable and expandable molded bodies based on reactive epoxy resins which are produced by means of conventional injection molding techniques. Such molded bodies are each precisely matched to the desired application in terms of their spatial design. As part of the production of the lightweight structural components, the curable and expandable molded bodies are then introduced on site into the structural components to be reinforced, and cured and foamed in a separate method step by heating (for example as part of the painting process). However, with this procedure, a correspondingly designed molded article and the injection molds necessary for its production have to be developed in a complex manner for each structural component to be reinforced; flexible use of these reinforcing agents is thus almost impossible.

Furthermore, this method has the disadvantage that the preparation, which is solid at room temperature, has to be heated to produce the molded bodies, which under certain circumstances can lead to the irreversible, highly exothermic curing process already being initiated. In some cases, a small amount of curing of the systems is even consciously accepted in order to optimize the dimensional stability and surface quality of the molded bodies.

Alternatively, for example, in WO-A2-2002/31077 two-component systems for stiffening structural components have been proposed, which systems cure at room temperature. However, such systems involve increased risks with regard to the dosing accuracy, which has a negative impact on both the expansion rate and the resulting mechanical properties. In addition, such systems which cure at room temperature result in structural foams which are inferior to the hot-cured systems in terms of their thermomechanical properties.

As a third alternative, paste-like structural adhesives can be used. However, these have the disadvantage of insufficient stability, in particular when they are applied in greater layer thicknesses. In addition, such paste-like structural adhesives tend to flow out of the targeted area of application during the heating process and thus tend not to develop their full effectiveness at the desired point. Another disadvantage is the low resistance to washing off in certain applications and insufficient expansion to fill the cavities.

In addition, in the current age of automating production processes using robots, it is desirable if the components for locally reinforcing and sealing (hollow) structural components can be applied directly by means of a robot. This saves time and money, and the production process can also be quickly adapted to other structural components and geometries by reprogramming the robot. For this purpose, it is, however, particularly desirable if the substance suitable for reinforcement and sealing can be applied directly by the robot.

Accordingly, it was the object of the present invention to provide preparations for the production of structural foams for locally reinforcing and sealing (hollow) structural components which overcome the disadvantages mentioned above.

Surprisingly, it has now been found that thermally expandable preparations which contain the combination of components described herein demonstrate such behavior that good applicability by means of conventional pumps is ensured, thus making automatic application by means of a robot possible, and also the applied preparation already has sufficient stability and adhesion before curing, so that the preparation is prevented from slipping out of the application area prior to curing or during the heating process. Furthermore, in addition to excellent initial adhesion, the preparations according to the invention also have very good adhesion of the expanded preparation. This adhesion after expansion ensures in particular that, in addition to good adhesion of the foam, there is effective and permanent sealing. In addition, the cured preparations are characterized by very high expansion rates of 250% and more as well as mechanical properties which correspond to those of conventional stiffening foams based on solid molded bodies.

The present invention therefore relates to preparations that are pumpable and thermally expandable at application temperatures in the range of 30 to 120° C., and contain

(a) at least one solid rubber;
(b) at least one liquid rubber;
(c) at least one thermally activatable blowing agent; and
(d) a curing agent system containing
at least one peroxide and
at least one quinone, quinone dioxime or dinitrosobenzene.

“At least one,” as used herein, means one or more, i.e., 1, 2, 3, 4, 5, 6, 7, 8, 9 or more. In relation to an ingredient, the expression refers to the type of ingredient and not to the absolute number of molecules. “At least one polymer” thus means, for example, at least one type of polymer, i.e., that one type of polymer or a mixture of a plurality of different polymers can be meant. Together with weight specifications, the expression relates to all compounds of the type indicated that are contained in the composition/mixture, i.e., that the composition does not contain any other compounds of this type beyond the indicated amount of the corresponding compounds.

A substance is “solid” if it is in the solid state of aggregation at 20° C. and 1013 mbar. The substance is in a solid state of aggregation if the geometry of the substance does not deform under the influence of gravity within 1 hour, in particular within 24 hours, under the specified conditions. In the context of the invention, “liquid” means that the corresponding compound/component is not in solid form under standard conditions, i.e., 20° C. and 1013 mbar. Therefore, pasty substances are also liquid in the context of this invention. Under standard conditions, a liquid substance is preferably flowable and thus, for example, can be poured out of a container. A liquid substance preferably has a viscosity of up to 250 Pa*s at 20° C. Unless stated otherwise, the viscosities are determined in the context of the present application under the following measurement conditions: rotation rheometer having a plate-plate geometry (PP20); measured in oscillation at 10% deformation and a frequency of 100 rad/s; layer thickness of the material=0.2 mm.

Unless explicitly indicated otherwise, all percentages that are cited in connection with the preparations described herein relate to wt. %, in each case based on the relevant preparation or composition.

Numbers stated herein with no decimal places refer to the full specified value with one decimal place. For example, “99%” stands for “99.0%.” Numbers stated herein with no decimal places refer to the full specified value with one decimal place.

The terms “about” or “approximately” in connection with a numerical value refer to a variance of ±10% in relation to the specified numerical value.

Unless stated otherwise, the molecular weights indicated in the present text relate to the weight-average molecular weight (Mw). The molecular weight Mw can be determined by gel permeation chromatography (GPC) according to DIN 55672-1:2007-08 with polystyrene as the standard and THF as the eluent. Except where indicated otherwise, the listed molecular weights are those which are determined by means of GPC. The number-average molecular weight Mn can also be determined by means of GPC, as indicated previously. Alternatively, Mn can also be determined on the basis of an end group analysis (hydroxyl number according to DIN 53240-1:2013-06) if the polymer allows this.

According to the invention, “preparations that are pumpable at application temperatures” are preparations which can be applied from a storage vessel to the application site at temperatures in the range of 30 to 120° C., preferably 30 to 80° C., using conventional pumps at a pressure of less than 200 bar, in particular of 6 to 180 bar. Preparations that can be applied from a storage vessel to the application site at application temperatures in the range of 40° C. to 60° C. using conventional pumps at a pressure of less than 200 bar, in particular of 6 to 180 bar, are particularly preferred.

Preparations according to the invention which are “pumpable at application temperatures” are very particularly preferred in the sense that said preparations have, at 60° C. and a pump pressure of 6 bar, a flow rate of at least 100 g/min, preferably of 150 g/min to 4,500 g/min, more preferably of 250 g/min to 3,000 g/min, when discharged from a completely filled, commercially available aluminum nozzle cartridge which has a capacity of 310 mL and an internal diameter of 46 mm, and the outlet opening of which has been opened by means of a cartridge piercing tool having an external diameter of 9 mm, without attaching a nozzle, at a temperature of 60° C. (after pre-heating for 45 minutes) and a pressure of 6 bar. The flow rate indicates the mass of preparation that can be discharged within 1 minute, and is accordingly given in g/min.

The preparation according to the invention contains at least one solid rubber and at least one liquid rubber as the first two components. Natural and/or synthetic rubbers are suitable for this. Examples of suitable rubbers are polybutadiene, preferably having a very high proportion of cis-1,4 double bonds (typically above 95%), styrene butadiene rubber, such as styrene-butadiene-styrene copolymers (SBS) or styrene-butadiene terpolymers (e.g., styrene-isoprene-butadiene polymers), butadiene acrylonitrile rubber, styrene isoprene rubbers, such as styrene-isoprene-styrene copolymers (SIS) or styrene-isoprene terpolymers, styrene-ethylene/propylene-styrene copolymers (SEPS), styrene-ethylene/ethylene/propylene-styrene copolymers (SEEPS), synthetic or natural isoprene rubber, polycyclooctenamer, butyl rubber or polyurethane rubber.

In one embodiment, the at least one solid rubber is selected from styrene butadiene rubbers and styrene isoprene rubbers, in particular from styrene-butadiene polymers and styrene-isoprene block copolymers, particularly preferably from styrene-butadiene polymers. The at least one solid rubber has, in particular, a weight-average molecular weight of greater than 100,000 g/mol. The at least one solid rubber is preferably contained in an amount of 1 to 30 wt. %, more preferably of 5 to 25 wt. %, particularly preferably of 8 to 20 wt. %, in each case based on the total weight of the preparation.

In a further embodiment, the at least one liquid rubber is selected from butadiene isoprene rubbers and styrene butadiene rubbers, in particular butadiene isoprene rubbers. The at least one liquid rubber has, in particular, a weight-average molecular weight of less than 100,000 g/mol, in particular less than 70,000 g/mol. The weight-average molecular weight of the liquid rubber is preferably in the range of 2,000 to 100,000 g/mol, in particular of 5,000 to 70,000 g/mol, more preferably of 10,000 to 50,000 g/mol. The at least one liquid rubber is preferably contained in an amount of 1 to 30 wt. %, more preferably of 5 to 25 wt. %, particularly preferably of 8 to 20 wt. %, in each case based on the total weight of the preparation.

As a further component that is essential to the invention, the thermally expandable preparations according to the invention contain a thermally activatable blowing agent. Suitable thermally activatable blowing agents are, in principle, all known blowing agents, for example “chemical blowing agents” which release gases upon decomposition when subject to thermal treatment, or “physical blowing agents,” i.e., in particular thermally expandable hollow spheres. Chemical blowing agents are preferred according to the invention.

A chemical blowing agent is understood, according to the invention, to mean compounds which decompose upon exposure to heat and thereby release gases.

Examples of suitable chemical blowing agents are azo compounds, hydrazide compounds, nitroso compounds and carbazide compounds, such as azobisisobutyronitrile, azodicarbonamide (ADCA), di-nitroso-pentamethylene tetramine (DNPT), 4,4′-oxybis(benzenesulfonic acid hydrazide) (OBSH), 4-methylbenzene sulfonic acid hydrazide, azocyclohexylnitrile, azodiaminobenzene, benzene-1,3-sulfonylhydrazide, benzene-4-sulfonohydrazide (BSH), calcium azide, 4,4′-diphenyldisulfonyl azide, diphenyl-sulfone-3,3′-disulfohydrazide, diphenyloxide-4,4′-disulfohydrazide, benzene-1,3-disulfohydrazide, trihydrazinotriazine, 5-phenyltetrazole (5-PT), p-toluenesulfonylhydrazide (TSH) and p-toluenesulfonyl semicarbazide (PTSS).

Another class of suitable blowing agents are the H-silanes, which are marketed by Huntsmann, for example, under the trade name Foaming Agent DY-5054.

Furthermore, the carbamates described in DE-A1-102009029030 are particularly suitable as chemical thermally activatable blowing agents within the meaning of the present invention.

Endothermic chemical blowing agents, in particular selected from bicarbonates, solid, optionally functionalized, polycarboxylic acids and salts, and mixtures thereof, are also suitable. These endothermic blowing agents have the advantage that they are neither harmful to health nor explosive and that smaller amounts of volatile organic compounds (VOC) are formed during expansion. The decomposition products are largely CO2 and water. Furthermore, the products produced therewith have a more uniform foam structure over the entire process temperature range used for curing. This can also result in lower water absorption. Finally, the decomposition temperature of the endothermic blowing agents, in particular of mixtures thereof, is lower compared with conventional exothermic blowing agents and therefore the process temperature can be reduced and energy can be saved.

Suitable bicarbonates (hydrogen carbonates) are those of formula XHCO3, where X can be any cation, in particular an alkali metal ion, preferably Na+ or K+, with Na+ being extremely preferred. Further suitable cations X+ can be selected from NH4+, ½ ZN2+, ½ Mg2+, ½ Ca2+, and mixtures thereof.

Suitable polycarboxylic acids include, without being limited thereto, solid, organic di-, tri-, or tetraacids, in particular hydroxyl-functionalized or unsaturated di-, tri-, tetra-, or polycarboxylic acids, such as citric acid, tartaric acid, malic acid, fumaric acid and maleic acid. The use of citric acid is particularly preferred. Citric acid is therefore advantageous, inter alia, because it is an ecologically sustainable blowing agent.

The salts of the acids mentioned and mixtures of two or more of the compounds described are also suitable. In the case of salts of polycarboxylic acids, the counterion is preferably selected from Na⁺, K⁺, NH₄⁺, ½ Zn²⁺, ½ Mg²⁺, ½ Ca²⁺, and mixtures thereof, with Na⁺ and K⁺, in particular Na⁺, being preferred. In particular, the salts of polycarboxylic acids demonstrate decomposition temperatures that are shifted toward higher temperatures, so that a broader temperature interval for decomposition can be set by mixing.

When using polycarboxylic acids, carbonates can preferably also be used. A mixture of hydrogen carbonates and carbonates as well as polycarboxylic acids is preferred, as a result of which different activation stages and decomposition reactions can be set in a targeted manner.

Particularly preferred blowing agents are sodium bicarbonate and/or citric acid/citrate; the blowing agent is very particularly preferably a mixture of sodium bicarbonate and citric acid/citrate. Compared with conventional exothermic blowing agents such as ADCA or OBSH, such a mixture has a very low start temperature of only 120-140° C., whereas OBSH has a start temperature of 140-160° C. and ADCA, activated with zinc salts, has a start temperature of 160-170° C. and, not activated, of 210-220° C.

According to the invention, the chemical thermally activatable blowing agents are preferably contained in an amount of 0.1 to 20 wt. %, in particular of 0.2 to 15 wt. %, more preferably 0.5 to 10.0 wt. %, in each case based on the total application preparation. A sulfonic acid hydrazide, in particular OBSH, and/or azodicarbonamide is particularly preferably contained as the at least one blowing agent, preferably in an amount of 0.1 to 10 wt. %, more preferably of 0.2 to 5 wt. %, particularly preferably of 0.5 to 3.5 wt. %, in each case based on the total weight of the preparation.

The “chemical blowing agents” according to the invention can advantageously be used in combination with activators and/or accelerators, such as zinc compounds (for example zinc oxide, zinc stearate, zinc ditoluene sulfinate, zinc dibenzenesulfinate), magnesium oxide, calcium oxide and/or (modified) ureas. The zinc compounds are particularly preferred according to the invention.

According to the invention, it does not matter whether the blowing agents are already used in activated form or whether the thermally expandable preparations contain a corresponding activator and/or accelerator, such as zinc ditoluene sulfinate, in addition to the blowing agent.

It has been found to be particularly advantageous if the thermally expandable preparations according to the invention contain the activators and/or accelerators, in particular the zinc compounds, in an amount of 0.05 to 2 wt. %, in particular of 0.1 to 1 wt. %, based on the total mass of the thermally expandable preparation.

Expandable plastics hollow microspheres based on polyvinylidene chloride copolymers or acrylonitrile/(meth)acrylate copolymers are preferably used as physical blowing agents. These are commercially available, for example, under the names “Dualite®” and “Expancel®” from Pierce & Stevens and Akzo Nobel, respectively.

It may be preferable according to the invention to use, in the thermally expandable preparations, a combination of at least one chemical thermally activatable blowing agent and at least one physical thermally activatable blowing agent.

The amount of blowing agent is preferably selected such that the volume of the thermally expandable compound, when heated to an activation temperature (or expansion temperature), increases irreversibly by at least 10%, preferably at least 50%, and in particular at least 100%. What is meant by this is that, in addition to the normal and reversible thermal expansion according to the coefficient of thermal expansion of the compound, the volume of said compound, by comparison with the starting volume at room temperature (20° C.), irreversibly increases when heated to the activation temperature in such a way that, after being cooled back down to room temperature, it is at least 10%, preferably at least 50%, and in particular at least 100%, greater than before. The specified degree of expansion thus refers to the volume of the compound at room temperature before and after the temporary heating to the activation temperature. The upper limit of the degree of expansion, i.e., the irreversible increase in volume, can be set by selecting the amount of blowing agent. Preferred upper limits are in the range of up to 1,000%, preferably up to 750%. Preferred ranges are 250 to 750%.

The activation temperature is preferably in the range of 120 to 220° C. This temperature should preferably be maintained for a period of time in the range of 10 to 150 minutes.

The thermally expandable preparation also contains a curing agent system containing at least one peroxide and at least one quinone, quinone dioxime or dinitrosobenzene. In particular, the combination of a peroxide curing agent and a curing agent based on quinones, quinone dioximes or dinitrosobenzene leads to excellent expansion properties and simultaneously good adhesion and elasticity of the resulting foam. This combination creates a good balance, with the preparation not curing too quickly. If the preparation cures too quickly, the surface could crack during expansion and the foam could collapse due to escaping gas. The curing agent system is preferably contained in an amount of 0.1 to 10 wt. %, more preferably of 0.5 to 5 wt. %, particularly preferably of 1 to 3 wt. %, in each case based on the total weight of the preparation.

In particular, organic peroxides, for example ketone peroxides, diacyl peroxides, peresters, perketals and hydrogen peroxides, are preferred according to the invention. Particularly preferred are, for example, cumene hydroperoxide, t-butyl peroxide, bis(tert-butylperoxy)diisopropylbenzene, di(tert-butylperoxyisopropyl)benzene, dicumyl peroxide, t-butyl peroxybenzoate, dialkyl peroxydicarbonate, diperoxy ketals (e.g 1,1-di-tert-butylperoxy-3,3,5-trimethylcyclohexane), ketone peroxides (e.g., methyl ethyl ketone peroxides), 4,4-di-tert-butylperoxy-n-butyl valerates and trioxepanes (e.g., 3,3,5,7,7-pentamethyl-1,2,4-trioxepane).

According to the invention, peroxides, commercially marketed for example by Akzo Nobel or Pergan, such as 3,3,5,7,7-pentamethyl-1,2,4-trioxepane, 2,5-dimethyl-2,5-di(tert-butylperoxy)hexane, di-tert-butyl peroxide, 2,5-dimethyl-2,5-di(tert-butylperoxy)hexane, tert-butyl cumyl peroxide, di-(tert-butylperoxyisopropyl)benzene, dicumyl peroxide, butyl-4,4-di(tert-butylperoxi)valerate, tert-butylperoxy-2-ethylhexyl carbonate, 1,1-di-(tert-butylperoxy)-3,3,5-trimethylcyclohexane, tert-butyl peroxybenzoate, di-(4-methylbenzoyl)peroxide and dibenzoyl peroxide, are particularly preferred. According to the invention, it can be particularly preferred to use di(tert-butylperoxyisopropyl)benzene, di(tert-butylperoxy)-3,3,5-trimethylcyclohexane and/or dicumyl peroxide as peroxide.

It has also been found to be advantageous according to the invention for the peroxides used to be substantially inert at room temperature and to be activated only when heated to relatively high temperatures (for example when heated to temperatures of between 130° C. and 240° C.). It is particularly advantageous according to the invention for the peroxide used to have a half-life of more than 60 minutes at 65° C., i.e., after the thermally expandable preparation containing the peroxide has been heated to 65° C. for 60 minutes, less than half of the peroxide used has decomposed. According to the invention, peroxides of this kind that have a half-life of 60 minutes at 115° C. may be particularly preferred.

Furthermore, a plurality of peroxides can also be used in combination, in particular those mentioned above as being preferred in combination.

It may also be advantageous for the at least one peroxide or the peroxides to be used in a form in which they are applied to a solid inert carrier, such as calcium carbonate and/or silica and/or kaolin.

The peroxide is preferably contained in an amount of 0.1 to 3 wt. %, more preferably of 0.5 to 2 wt. %, in each case based on the total weight of the preparation.

Furthermore, the curing agent system contains at least one quinone, quinone dioximes or dinitrosobenzene, in particular 1,4-benzoquinone dioxime, nitrosobenzene or dinitrosobenzene, in particular 1,4-benzoquinone dioxime.

The quinone, quinone dioxime or dinitrosobenzene, in particular 1,4-benzoquinone dioxime, is preferably contained in an amount of 0.1 to 3 wt. %, more preferably of 0.5 to 2 wt. %, in each case based on the total weight of the preparation.

In addition, the curing agent system can also contain, however, other curing agents for rubber-based systems, such as sulfur-based curing agents. However, it is a great advantage of the present invention that, in the thermally expandable preparations, further curing agents for rubber-based systems, in particular sulfur-based curing agents, can be dispensed with. In a preferred embodiment, the thermally expandable preparation is substantially free of elemental sulfur. “Substantially free of,” as used in this context, means that the amount of the corresponding substance in the preparation is less than 0.05 wt. %, preferably less than 0.01 wt. %, more preferably less than 0.001 wt. %, based on the total weight of the preparation, in particular that the preparation is completely free of said substance.

In a preferred embodiment, the thermally expandable preparation also contains at least one adhesion promoter, which is preferably selected from epoxides, anhydride-grafted polybutadiene and/or isocyanates. The adhesion promoter is preferably contained in an amount of 1 to 15 wt. %, more preferably of 2 to 10 wt. %, in each case based on the total weight of the preparation.

Suitable epoxides are all common epoxy resins. A large number of epoxides, in particular polyepoxides, having at least two 1,2-epoxy groups per molecule are suitable as epoxy resins. The epoxide equivalent of these polyepoxides can vary between 150 and 50,000, preferably between 170 and 5,000. In principle, the polyepoxides may be saturated, unsaturated, cyclic or acyclic, aliphatic, alicyclic, aromatic or heterocyclic polyepoxide compounds. Examples of suitable polyepoxides include polyglycidyl ethers produced by reacting epichlorohydrin or epibromohydrin with a polyphenol in the presence of an alkali. Polyphenols suitable for this are, for example, resorcinol, pyrocatechol, hydroquinone, bisphenol A (bis-(4-hydroxy-phenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthaline. Other polyphenols that are suitable as the basis for polyglycidyl ethers are the known condensation products of phenol and formaldehyde or acetaldehyde of the novolac resin type. Aromatic epoxy resins, in particular bisphenol A-based epoxy resins, are particularly preferred.

In the case of an epoxide as the adhesion promoter, it is advantageous if a thermally activatable or latent curing agent for the epoxy resin binder system is also contained. Guanidines, substituted guanidines, substituted ureas, melamine resins, guanamine derivatives, cyclic tertiary amines, aromatic amines and/or mixtures thereof can be used as suitable thermally activatable or latent curing agents. In this case, the curing agents can be stoichiometrically involved in the curing reaction. However, they may also have a catalytic effect. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and very particularly cyanoguanidine (dicyandiamide). Representatives of suitable guanamine derivatives which may be mentioned are alkylated benzoguanamine resins, benzoguanamine resins or methoxymethyl-ethoxymethylbenzoguanamine.

In the case of anhydride-grafted polybutadiene as the adhesion promoter, maleic anhydride-grafted polybutadienes are particularly preferred. These polymers then contain succinic anhydride groups.

Suitable isocyanates include the known isocyanates, in particular polyisocyanates. Isocyanates having two or more isocyanate groups are suitable as polyisocyanates in the polyisocyanate components. The polyisocyanates preferably contain 2 to 10, more preferably 2 to 5, even more preferably 2 to 4 and in particular 2, isocyanate groups per molecule. The use of isocyanates having a functionality of more than two can be advantageous in some circumstances since polyisocyanates of this kind are suitable as crosslinking agents. Particular preference is therefore given to mixtures of compounds having two or more isocyanate groups, for example oligomer mixtures.

Examples of suitable polyisocyanates are 1,5-naphthylene diisocyanate, 2,4′-, 2,2′- or 4,4′-diphenylmethane diisocyanate (MDI), hydrogenated MDI (H12MDI), allophanates of MDI, xylylene diisocyanate (XDI), m- and p-tetramethylxylylene diisocyanate (TMXDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, the isomers of toluene diisocyanate (TDI), 1-methyl 2,4-diisocyanato-cyclohexane, 1,6-diisocyanato-2,2,4-trimethylhexane, 1,6-diisocyanato-2,4,4-trimethylhexane, 1-isocyanatomethyl-3-isocyanato-1,5,5 trimethylcyclohexane (IPDI), chlorinated and brominated diisocyanates, phosphorus-containing diisocyanates, 4,4′-di-isocyanatophenylperfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid bis-isocyanatoethyl ester, trimethylhexamethylene diisocyanate, 1,4-diiso cyanatobutane, 1,12-diisocyanatododecane and dimer fatty acid diisocyanate, and aliphatic isocyanates such as hexamethylene diisocyanate, undecane diisocyanate, dodecamethylene diisocyanate, 2,2,4-trimethylhexane-2,3,3-trimethylhexamethylene, 1,3- or 1,4-cyclohexane diisocyanate, 1,3- or 1,4-tetramethylxylene diisocyanate, isophorone diisocyanate, 4,4-dicyclohexylmethane diisocyanate or lysine ester diisocyanate. An aromatic polyisocyanate is preferably used as the polyisocyanate as the adhesion promoter. In an aromatic polyisocyanate, the NCO groups are bonded to aromatic carbon atoms.

In a preferred embodiment, the thermally expandable preparation also contains at least one peroxidically crosslinkable polymer, selected from binary copolymers containing at least one monomer unit selected from vinyl acetate, (meth)acrylic acids, styrene and derivatives thereof, and terpolymers based on at least one first monomer selected from the monounsaturated or polyunsaturated hydrocarbons, in particular ethylene, and at least one second monomer selected from the (meth)acrylic acids and derivatives thereof, in particular (meth)acrylic esters, and at least one third monomer selected from epoxy-functionalized (meth)acrylates, in particular glycidyl (meth)acrylate, and combinations thereof. This peroxidically crosslinkable polymer is contained in addition to the contained rubbers and constitutes a further component. A person skilled in the art uses the expression “peroxidically crosslinkable” to refer to polymers in which a hydrogen atom can be abstracted from the main chain or a side chain by the action of a radical initiator, such that a radical is left behind that acts on other polymer chains in a second reaction step.

According to the invention, “binary copolymers” are understood to mean all copolymers which result from a polymerization reaction from two monomers which are different from one another. Of course, according to the invention, copolymers in the polymer chain of which further monomers, for example due to degradation reactions or impurities, are incorporated in such small amounts that they do not affect the properties of the binary copolymer should also be included. The peroxidically crosslinkable binary copolymer contains at least one monomer unit selected from vinyl acetate, (meth)acrylic acids, styrene and derivatives thereof. As usual, the prefix “(meth)” before “acrylate” means that these monomers can be acrylic acids and/or derivatives thereof as well as methacrylic acids and/or derivatives thereof. Derivatives of (meth)acrylic acids are in particular (meth)acrylic esters; the alcohol component of the ester is preferably selected from those which contain 1 to 8 carbon atoms. Particularly preferred monomer units of this group are vinyl acetate, butyl acrylate, methyl acrylate, ethyl acrylate and 2-ethylhexyl acrylate. According to the invention, vinyl acetate is a particularly preferred representative of this group.

The second monomer of the binary copolymer is preferably selected from the alkenes. Ethylene is a particularly preferred second monomer of the binary copolymer within the meaning of the present invention.

In a first preferred embodiment, the at least one peroxidically crosslinkable polymer is selected from ethylene-vinyl acetate copolymers, functionalized ethylene-vinyl acetate copolymers, functionalized ethylene-butyl acrylate copolymers, ethylene-methyl acrylate copolymers, ethylene-ethyl acrylate copolymers, ethylene-butyl acrylate copolymers, functionalized ethylene-butyl acrylate copolymers, ethylene-(meth)acrylic acid copolymers and ethylene-2-ethylhexyl acrylate copolymers. In a particularly preferred embodiment, the at least one peroxidically crosslinkable binary copolymer is selected from ethylene-vinyl acetate copolymers, functionalized ethylene-vinyl acetate copolymers, ethylene-butyl acrylate copolymers, functionalized ethylene-butyl acrylate copolymers, ethylene-methyl acrylate copolymers, ethylene-ethyl acrylate copolymers, ethylene-(meth)acrylic acid copolymers, and ethylene-2-ethylhexyl acrylate copolymers.

According to the invention, a “functionalized copolymer” is understood to be a copolymer which is provided with additional hydroxide groups, carboxyl groups, anhydride groups, acrylate groups and/or glycidyl methacrylate groups, preferably at the chain ends.

Ethylene-vinyl acetate copolymers, ethylene-butyl acrylate copolymers and functionalized derivatives thereof are particularly advantageous within the meaning of the present invention. Ethylene-vinyl acetate copolymers, in particular the representatives which have no functionalization, can be very particularly preferred according to the invention. Ethylene-vinyl acetate copolymers having a vinyl acetate proportion of 25-50 wt. %, based on the total mass of the binary copolymer, are very particularly preferably contained and are particularly preferred according to the invention.

Alternatively or additionally, at least one terpolymer based on at least one first monomer selected from the monounsaturated or polyunsaturated hydrocarbons, at least one second monomer selected from the (meth)acrylic acids and derivatives thereof, and at least one third monomer selected from epoxy-functionalized (meth)acrylates can as the peroxidically crosslinkable polymer.

According to the invention, it has been found to be preferred if the first monomer unit of the terpolymer is a monounsaturated or polyunsaturated acyclic hydrocarbon; alkenes and dienes are particularly preferred representatives of this group; according to the invention, the monomer units ethylene, propylene, 1,2-butadiene, 1,3-butadiene and isoprene are very particularly preferred representatives of this group, with ethylene being most preferred.

The second comonomer of the terpolymer is selected from (meth)acrylic acid and derivatives thereof. As usual, the prefix “(meth)” before “acrylate” means that these monomers can be acrylic acids and/or acrylic esters as well as methacrylic acids and/or methacrylic esters. If the terpolymer according to the invention contains acrylic esters and/or methacrylic esters, the alcohol component of the ester is preferably selected from those containing 1 to 6 carbon atoms. In particular, methyl esters, ethyl esters and butyl esters can be used.

In a preferred embodiment of the present invention, the third comonomer of the component (e) is selected from glycidyl (meth)acrylic esters.

According to the invention, glycidyl (meth)acrylic esters are understood to mean the esters of acrylic acid or methacrylic acid with glycidol (2,3-epoxypropan-1-ol).

Terpolymers of ethylene with (meth)acrylic esters, in particular methyl acrylate and butyl acrylate, and glycidyl (meth)acrylic esters, in particular glycidyl methacrylate, are particularly preferred. The proportion of (meth)acrylic esters is preferably 10 to 30 wt. %, more preferably 20 to 30 wt. %, and the proportion of glycidyl (meth)acrylic esters is preferably 5 to 20 wt. %, more preferably 5 to 10 wt. %, with the remainder ethylene, in each case based on the total weight of the terpolymer. Ethylene-butyl acrylate-glycidyl methacrylate and ethylene-methyl acrylate-glycidyl methacrylate terpolymers, and mixtures thereof, are preferred.

Even if this component is defined according to the invention as a terpolymer, the invention should of course also include copolymers that contain other monomers, for example from degradation reactions or impurities, in such small amounts that they do not affect the properties of the terpolymers according to the invention.

In various embodiments, the peroxidically crosslinkable polymers, in particular the binary copolymers, are characterized by a high melt flow index. The peroxidically crosslinkable polymers, preferably binary copolymers, in particular the ethylene/vinyl acetate copolymer, preferably have a melt flow index greater than/equal to 100 g/10 min, more preferably greater than/equal to 200 g/10 min, in particular greater than/equal to 300 g/10 min. The peroxidically crosslinkable polymers, preferably binary copolymers, in particular the ethylene/vinyl acetate copolymer, particularly preferably have a melt flow index of 100 to 1,000 g/10 min, in particular 200 to 700 g/10 min. The melt flow index of the peroxidically crosslinkable polymers is determined according to the invention in a melt flow measuring device, the polymer being melted at 190° C. in a heatable cylinder and being pushed through a defined standard nozzle at a pressure produced by the bearing load (2.16 kg) (DIN EN ISO 1133). The mass of material being extruded is measured as a function of time. The melting temperature is preferably in the range of 40 to 93° C.

The thermally expandable preparations preferably contain up to 10 wt. % of at least one or more of the peroxidically crosslinkable polymers, preferably binary copolymers. Thermally expandable preparations containing 0.1 to 3 wt. % of at least one or more of the peroxidically crosslinkable binary copolymers, in particular of an ethylene/vinyl acetate copolymer, in each case based on the total mass of the thermally expandable preparation, are particularly preferred.

The use of the copolymers/terpolymers according to the invention, preferably the binary copolymers, in particular an ethylene/vinyl acetate copolymer, in the preparations according to the invention can have a particularly advantageous effect on the adhesion of the foamed foam. In particular, an advantageous melt flow index of the polymers can improve the adhesion of the expanding foam in a cavity on all surfaces.

In particular, a liquid polymer selected from liquid hydrocarbon resins and liquid polyolefins can be contained as a further component, preferably in an amount of 5 to 35 wt. %, more preferably of 10 to 30 wt. %, in each case based on the total weight of the preparation. Another liquid polymer can be particularly advantageous for adapting or further improving the rheological properties.

According to the invention, “hydrocarbon resins” denote, inter alia, thermoplastic polymers that can be obtained from petroleum fractions. These can, for example, have an average molar mass of at most 2,500 g/mol. In the context of the present application, the average molar mass of polymers is generally understood to mean the weight-average molar mass. In the context of the present invention, the weight-average molecular weight (Mw) can be determined by means of gel permeation chromatography (GPC) with polystyrene as the standard, as defined above.

The hydrocarbon resins can be completely aliphatic or completely aromatic, or they can have aliphatic and aromatic structures. They can also be aromatically modified aliphatic resins.

If contained, the hydrocarbon resins are preferably contained in the thermally expandable preparations in an amount of up to 35 wt. %, in particular of 5 to 35 wt. %, very particularly preferably of 10 to 25 wt. %, in each case based on the total mass of the thermally expandable preparation.

The liquid polymer can also be selected from liquid polyolefins. Polyisobutylene is particularly preferred here, in particular having a molecular weight Mw of up to 3,000 g/mol. Such polymers, when they are contained in the preparations according to the invention, are preferably contained in amounts of up to 10 wt. %, more preferably 3 to 8 wt. %.

In addition to the constituents mentioned, the thermally expandable compounds can also contain other customary components, such as dyes, fillers and antioxidants.

Fillers include, for example, the various ground or precipitated chalks, calcium magnesium carbonates, talc, graphite, barite, silicic acid or silica and in particular silicate fillers such as mica, for example in the form of chlorite, or silicate fillers of the aluminum-magnesium-calcium silicate type, for example wollastonite. Talc is a particularly preferred filler.

The fillers are preferably used in an amount of 0 to 60 wt. %, in particular 5 to 18 wt. %, in each case based on the mass of the entire thermally expandable preparation.

Chromophoric components, in particular black dyes based on carbon blacks, are preferably contained in the thermally expandable preparations according to the invention in an amount of 0 to 8 wt. %, in particular of 0.1 to 4 wt. %, in each case based on the mass of the entire thermally expandable preparation.

It is possible to use, for example, sterically hindered phenols and/or sterically hindered thioethers and/or sterically hindered aromatic amines, for example bis-(3,3-bis-(4′-hydroxy-3-tert-butylphenyl)butanoic acid)glycol ester as antioxidants or stabilizers.

Antioxidants or stabilizers are preferably contained in the thermally expandable preparations according to the invention in an amount of 0 to 2 wt. %, in particular of 0.1 to 0.5 wt. %, in each case based on the mass of the entire thermally expandable preparation.

The thermally expandable preparations according to the invention can be prepared by mixing the selected components in any suitable mixer, for example a dispersion mixer, a planetary mixer, a twin-screw mixer, a continuous mixer or an extruder, in particular a twin-screw extruder.

Although it can be advantageous to heat the components slightly to make it easier to achieve a homogeneous and uniform compound, care must be taken to ensure that temperatures which cause the thermally activatable curing agent and/or the thermally activatable blowing agent to be activated are not reached.

The thermally expandable preparations according to the invention are preferably formulated such that they are solid at 20° C.

Until they are used, the preparations according to the invention are preferably stored in nozzle cartridges or barrels, such as sealed drums.

At the time of use, the preparation according to the invention is transported from the storage container to the application site and is applied at said site using conventional heated pumps. Said preparation can be applied to a layer thickness of 5 cm without difficulty, such that even relatively large cavities, such as tubes having a corresponding internal diameter, can easily be filled.

The thermally expandable preparation applied expands by being heated, the preparation being heated for a particular time period and to a particular temperature which is sufficient for bringing about the activation of the blowing agent and the curing agent system.

Depending on the composition of the preparation and the requirements of the production line, these temperatures are usually in the range of 130° C. to 240° C., preferably 150° C. to 200° C., with a residence time of 10 to 90 minutes, preferably of 15 to 60 minutes.

In principle, the type of the heat source is not important, and so the heat can be supplied for example by a hot air blower, by irradiation with microwaves, by magnetic induction, or by heating tongs. In the field of vehicle construction and in fields of technology involving associated production processes, it is particularly advantageous for the preparations according to the invention to expand when the vehicle passes through the furnace for curing the cathodic dip paint or for baking the powder coatings, and therefore a separate heating step can be dispensed with.

The present invention secondly relates to a method for stiffening and/or reinforcing structural components having thin-walled structures, in particular tubular structures, and/or for sealing cavities in structural components. In such methods, a pumpable, thermally expandable preparation according to the invention can be applied to the surface of the structure to be reinforced or introduced into the cavity of the structural component to be sealed at a temperature below 120° C., preferably at a pump pressure of less than 200 bar, and this preparation can be cured at a later point in time, preferably at temperatures above 130° C. The curing leads to the thermally expandable preparation expanding, thus stiffening the structural component/sealing the cavity.

According to the invention, the preparations are particularly preferably applied in a temperature range of 30° C. to 80° C. Application at an application pressure of from 6 bar to 180 bar is also particularly preferred.

The actual curing takes place according to the invention at a “later point in time.” For example, according to the invention, it is conceivable that the structural components to be stiffened or sealed be coated/filled with the pumpable, thermally expandable preparations and then put into intermediate storage. Intermediate storage may also include, for example, transportation to another plant. Such intermediate storage can last up to several weeks.

In another embodiment, however, it is also conceivable that the structural components to be stiffened or sealed be subject to a curing step shortly after being coated/filled with the pumpable, thermally expandable preparation. This may take place immediately or, in the case of assembly-line production, after the components have arrived at one of the subsequent stations. In the context of this embodiment, it is particularly preferable according to the invention for the curing step to take place within 24 h, in particular within 3 h, after the preparations according to the invention have been applied.

The pumpable, thermally activated preparations according to the invention, or the foams resulting therefrom, can be used in all products which have cavities or have tube structures to be reinforced. These products are, for example, in addition to vehicles, aircraft, domestic appliances, furniture, buildings, walls, partitions or boats, and all devices having a supporting frame structure formed of tubes, for example sports equipment, mobility aids, frameworks and bicycles.

Examples of sports equipment in which the present invention can be used advantageously are bicycles, fishing nets, fishing rods, goal posts, tennis net posts, and basketball hoop structures.

According to the invention, the term “bicycle” is understood to be any usually two-wheeled, single-track vehicles driven by operating pedals.

In addition to the conventional bicycle structures in which the rider adopts a seated position, recumbent bicycles, for example, are also intended to be included according to the invention. In addition to the conventional fixed frame, structures comprising hinges, such as folding bicycles, are also included according to the invention. Vehicles having three or more wheels are also intended to be included.

The preparations according to the invention can, for example, reinforce the constituents of a diamond frame, a sloping frame, a truss frame, a cross frame, a trapezoidal frame, an anglais frame, a gooseneck frame, a wave frame, an easy boarding frame or a Y frame.

Furthermore, the preparations according to the invention can be used to reinforce the frame structures of mobility aids, such as wheelchairs, rollators, crutches, assistive canes or walking frames.

In the field of vehicle construction, the use of the preparations according to the invention has been found to be advantageous particularly for the construction of the driver's safety cage or the passenger compartment, since it can provide the structure with a large amount of stability and, at the same time, a low weight. The preparation according to the invention can be used advantageously in particular in the construction of all classes of racing cars (Formula I, touring cars, rally vehicles, etc.).

Another preferred field of application of the present invention is the field of tools. There are no fundamental restrictions with regard to the type of tools. For example, said tools may be tradesmen's equipment, specialist tools, gardening equipment, such as spades or wheelbarrows, or kitchen equipment. Common to all these structural components is the fact that the preparation according to the invention makes it possible to stabilize the structure without significantly increasing the total weight.

Furthermore, the preparations according to the invention can advantageously be used to stabilize frames. According to the invention, “frames” are understood to be lateral surrounds, such as picture frames, window frames or door frames.

Another field of application is the reinforcement of all types of frameworks. In this field of application too, a high level of stability of the accordingly reinforced structures is paramount. The frameworks in which the preparation according to the invention can be used include, for example, all types of ladders, but also construction site scaffolding, structural frameworks for exhibition stand construction, structures for concert stages, such as supporting and mounting structures used as crossbeams, and lighting poles for stadiums or spectator stands.

Another broad field of application is the field of street furniture. This field includes traffic light and lighting systems as well as all other structures, such as bus shelters, platform railings, seat structures, road signs, bicycle stands or crash barriers.

With regard to the further details of this subject of the present invention, what has already been said in relation to the first subject applies, mutatis mutandis.

The present invention thirdly relates to the use of a pumpable, thermally expandable preparation according to the invention for stiffening and/or reinforcing structural components having thin-walled structures, in particular tubular structures, and to the use of a pumpable, thermally expandable preparation according to the invention for (acoustically) sealing cavities in structural components and/or for sealing cavities in structural components against water and/or moisture.

With regard to the details of this subject of the present invention, what has already been said in relation to the other subjects applies, mutatis mutandis.

The present invention fourthly relates to a structural component which optionally has a thin-walled structure and has been stiffened and/or reinforced and/or sealed by means of curing using a preparation according to the invention.

All embodiments disclosed in connection with the preparations of the inventions can also be transferred to the methods and uses and vice versa.

The following examples are intended to explain the invention in greater detail; the selection of the examples should not limit the scope of the subject matter of the invention.

### EXAMPLES

The following thermally expandable preparations were produced. Unless otherwise noted, the quantitative data are given in weight percent.

| COMPONENT | Example 1 | Example 2 | Example 3 | Example 4 |
|---|---|---|---|---|
| Solid styrene-butadiene copolymer | 5.73 | 9.12 | 20 | 15 |
| Amorphous carbon black | 3.88 | 1.82 | 2 | 2 |
| Calcium dioxide | 2.82 | 2.46 | 2.7 | 2.7 |
| Coated calcium carbonate | 15.53 | 13.59 | 13.11 | 14.24 |
| Ethylene-vinyl acetate copolymer | | 1.82 | 2 | 2 |
| Calcium carbonate | 27.21 | 22.0 | | |
| Benzoquinone dioxime | 0.87 | 0.77 | 0.84 | 3.36 |
| Benzenesulfinic acid zinc salt | 0.19 | 0.17 | 0.19 | 0.19 |
| Azodicarbonamide | 1.84 | 6.16 | 13 | 16 |
| Expandable hollow microspheres | 2.43 | | | |
| Dicumyl peroxide | | 0.76 | 0.83 | 0.83 |
| Bis(tert-butylperoxyisopropyl)benzene | 2.17 | | | |
| Dicyandiamide | | 0.46 | 0.5 | 0.5 |
| Epoxy resin | | 3.65 | 4.0 | 4 |
| Maleic anhydride-grafted polybutadiene | 6.31 | | | |
| Diisononyl phthalate | 3.88 | 3.4 | 3.73 | 3.73 |
| Liquid butadiene-isoprene copolymer | 12.14 | 10.62 | 11.65 | |
| Liquid styrene-butadiene copolymer | | | | 10 |
| Aromatic hydrocarbon resin in oil | 14.99 | 23.2 | 25.45 | 25.45 |
| TEST RESULTS | | | | |
| Expansion rate in % | | | | |
| 25 minutes, 160° C. | 440 | 400% | 700% | 900% |
| 25 minutes, 180° C. | 470 | 500% | 1000% | 1000% |
| 40 minutes, 200° C. | 480 | 400% | 700% | 800% |
| Washout resistance | 2 | 2 | 2 | 2 |

Specification of components used:

| | |
|---|---|
| Solid styrene-butadiene copolymer | SBR with Mw > 300,000 both uncrosslinked and |
| | pre-crosslinked |
| Liquid styrene-butadiene copolymer | SBR with Mw < 20,000 |
| Ethylene-vinyl acetate copolymer | 28% vinyl acetate content, MFR (190° C./2.16 kg) |
| | 400 g/10 min, melting point 60° C. |
| Liquid butadiene-isoprene copolymer | liquid; Mw 48,000, density 0.88 g/cm³ |
| Aromatic hydrocarbon resin in oil | liquid; melting point 15° C. |
| Benzoquinone dioxime | 1,4-para-benzoquinonedioxime in 65% paste |
| Epoxy resin | <700 Mw; epoxy group content 5,200-5,500 mmol/kg |

To produce the thermally expandable preparations according to the invention, the polymers and resins contained were processed step-by-step with fillers at RT in a kneader or, if necessary, with heating to up to 90° C. to form a homogeneous dough. The other non-reactive components such as fillers, carbon black, stabilizers and plasticizers, if any, were then added one after the other and kneaded further until the formulation was smooth.

At below 60° C., all reactive components such as benzoquinone dioxime, peroxides, activators and catalysts, calcium oxide and blowing agent were then added and slowly kneaded in until the adhesive was homogeneously mixed. Finally, the mixtures were homogenized for a further 10 minutes under a vacuum of less than 100 mbar and filled into cartridges.

All preparations exhibit uniform expansion, with a uniform, fine-pored foam being formed. The foam does not shrink or have any surface cracks.

Also, as a result of the preparation being stored in a humidity chamber (30° C./85% relative humidity/8 days), the materials do not exhibit any changes in properties and the material does not mushroom, either. The foam adheres to the steel substrates CRS, ELO; HDG, ZnMg very well and has up to 100% cohesive failure. The water absorption (after 24 h in water) of the foams also has an excellent, low weight increase of <5 wt. % in a direct measurement and <0.5 wt. % after re-drying (24 h), the foams from examples 2 to 4 having particularly good values.

### Determination of Expansion:

To determine the expansion, test specimens having dimensions of approximately 20 mm×8-10 mmø round bead portions were pressed out of the cartridges produced from the example formulations at approximately 40-60° C. and these were introduced into a convection oven, which was heated to the temperatures specified in the tables (heating time approximately 7 to 10 minutes). The test specimens were then left at this temperature for the period specified in the tables (including heating time). The expansion at 180° C. corresponds to the ideal conditions that are achieved during curing in vehicle construction. The expansion at 160° C. simulates the underfiring conditions and the expansion at 200° C. simulates the overfiring conditions.

The degree of expansion [%] was determined by the water displacement method according to the formula

$$Expansion = \frac{( m 2 - m 1 )}{m 1} \times 100$$

m1=mass of the test specimen in its original state in deionized water
m2=mass of the test specimen after baking in deionized water.

### Determination of Washout Resistance:

To determine the washout resistance, round beads having a geometry of 150 mm×10 mmø were applied at 40-60° C. to a prepared metal sheet of approximately 200 mm×30 mm and cooled for at least 1 h. The metal sheet prepared in this way is clamped in a holder of a rod agitator having a 12 cm radius, and immersed in a bath at 55° C., the rod agitator is set to a speed of rotation of 60 min⁻¹ and started. After 10 minutes the stirrer is switched off and the sample holder is lifted out of the water. The samples are removed from the holder and assessed. At least three test specimens are to be made.

The evaluation is based on the following rating scale:

0=unchanged compared with the initial state
1=little deformation
2=significant deformation without material washout
3=strong deformation, but without material washout
4=very strong deformation with material washout
5=material removal, but the originally wetted area is still covered in material
6=almost complete material removal except for small residual amounts

1. A thermally expandable preparation that is pumpable at application temperatures in a range of 30 to 120° C., and contains
(a) at least one solid rubber;
(b) at least one liquid rubber;
(c) at least one thermally activatable blowing agent; and
(d) a curing agent system containing
at least one peroxide and
at least one quinone, quinone dioxime or dinitrosobenzene.

2. The thermally expandable preparation of claim 1, wherein the at least one solid rubber is selected from styrene butadiene rubbers and styrene isoprene rubbers and/or is contained in an amount of 1 to 30 wt. %, in each case based on total weight of the preparation.

3. The thermally expandable preparation of claim 1, wherein the at least one liquid rubber is selected from butadiene-isoprene block copolymers and/or is contained in an amount of 1 to 30 wt. %, in each case based on total weight of the preparation.

4. The thermally expandable preparation of claim 1, wherein a sulfonic acid hydrazide and/or azodicarbonamide is contained as the at least one blowing agent, in an amount of 0.1 to 10 wt. %, in each case based on total weight of the preparation.

5. The thermally expandable preparation of claim 1, wherein the curing agent system is contained in an amount of 0.1 to 10 wt. %, in each case based on total weight of the preparation.

6. The thermally expandable preparation of claim 1, further comprising at least one adhesion promoter present in an amount of 2 to 10 wt. %, in each case based on total weight of the preparation.

7. The thermally expandable preparation of claim 1, further comprising at least one peroxidically crosslinkable polymer selected from
binary copolymers containing at least one monomer unit selected from vinyl acetate, (meth)acrylic acids, styrene and derivatives thereof, and
terpolymers based on at least one first monomer selected from the monounsaturated or polyunsaturated hydrocarbons, and at least one second monomer selected from (meth)acrylic acids and derivatives thereof, and at least one third monomer selected from epoxy-functionalized meth(acrylates), and
combinations thereof.

8. The thermally expandable preparation of claim 7, wherein an ethylene/vinyl acetate copolymer, having a melt flow index of greater than/equal to 200 g/min, is contained as at least one peroxidically crosslinkable polymer.

9. The thermally expandable preparation of claim 7, wherein the at least one peroxidically crosslinkable polymer comprises at least one terpolymer based ethylene, (meth)acrylic esters, and epoxy-functionalized meth(acrylates).

10. The thermally expandable preparation of claim 1, further comprising at least one liquid polymer selected from
liquid hydrocarbon resins, and
liquid polyolefins present in an amount of 5 to 35 wt. %, in each case based on the total weight of the preparation.

11. The thermally expandable preparation of claim 1, further comprising fillers, antioxidants, activators and/or dyes.

12. The thermally expandable preparation of claim 1, comprising:
8 to 20 wt. % of (a) the at least one solid rubber;
8 to 20 wt. % of (b) the at least one liquid rubber;
0.5 to 3.5 wt. % of (c) the at least one thermally activatable blowing agent; and
1 to 3 wt. % of (d) the curing agent system containing
at least one peroxide and
at least one quinone, quinone dioxime or dinitrosobenzene; and
1 to 15 wt. % of at least one adhesion promoter selected from epoxides, anhydride-grafted polybutadiene isocyanates;
amounts in each case based on total weight of the preparation.

13. The thermally expandable preparation of claim 12, further comprising at least one peroxidically crosslinkable polymer selected from
binary copolymers containing at least one monomer unit selected from vinyl acetate, (meth)acrylic acids, styrene and derivatives thereof, and
terpolymers based on at least one first monomer selected from the monounsaturated or polyunsaturated hydrocarbons, and at least one second monomer selected from the (meth)acrylic acids and derivatives thereof, and at least one third monomer selected from epoxy functionalized meth(acrylates), and
combinations thereof.

14. The thermally expandable preparation of claim 13, wherein an ethylene/vinyl acetate copolymer is contained as at least one peroxidically crosslinkable polymer.

15. The thermally expandable preparation of claim 13, wherein the at least one peroxidically crosslinkable polymer comprises at least one terpolymer based ethylene, (meth)acrylic esters, and epoxy functionalized meth(acrylates).

16. The thermally expandable preparation of claim 12, further comprising at least one liquid polymer present in an amount of 5 to 35 wt. % and selected from
a. liquid hydrocarbon resins, and
b. liquid polyolefins.

17. A method for stiffening and/or reinforcing structural components having thin-walled structures, or for sealing cavities in structural components, in particular tubular structures, wherein a thermally expandable preparation of claim 1, is applied to the surface of the structure to be stiffened and/or reinforced or introduced into the cavity of the structural component to be sealed at a temperature below 120° C., and at a pump pressure of less than 200 bar, and this preparation is cured at a later point in time, at temperatures above 130° C.

18. A structural component, optionally having a thin-walled structure, stiffened and/or reinforced and/or sealed by means of curing using a thermally expandable preparation according to claim 1.
